(19) United States
(12) Patent Application Publication
(10) Pub. No.: US 2006/0183361 A1
(43) Pub. Date: Aug. 17, 2006

(54) Positioning apparatus of a memory-card connector

(76) Inventor: Shin-Nan Kan, Hsinchu Shien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/055,059

(22) Filed: Feb. 11, 2005

(51) Int. Cl. H01R 13/62

(52) U.S. Cl. 439/159

(57) ABSTRACT

The invention relates to a positioning apparatus of a memory-card connector, which mainly provides an arm-slice extended sideward from its cap to press over outer or fixed end of a control rod. A space is provided at a position relating to inner or active end of the control rod. The arm-slice can provides enough elastic strength for pressing the control rod at certain area as moved in a slider of the connector. And the space allows the active end of the rod being moved without limitation that the connector can therefore be manufactured more thinly for convenient utilization.

### FIELD OF THE INVENTION

The present invention relates to an improvement of a positioning apparatus of a memory-card connector, which includes an elastic arm-slice for effectively positioning a control-rod relating to a slider placed in the connector and the connector can be thinner for convenient use.

### BACKGROUND OF THE INVENTION

It is known that a memory-card with small volume is widely used for storing a large amount of electronic data. The memory-card must be received in a connector for reading the data. The method of connection between the memory-card and the connector is to insert the memory-card into the connector directly. In order to take out the memory-card from the connector, one can just press the memory-card again. The movement and structure are shown in FIG. 1 to 4. A slider (2) is placed in one side of the connector (1), which has an inner spring (21) and a front Y-type groove (22) with a positioning block (23) therein. In the groove (22), there are four different levels provided around the block (23). Hence, an active end (31) of a control-rod (3) can be moved around the block (23). As shown in FIGS. 1 and 2, the connector (1) is empty before a memory-card is inserted. When the memory-card is inserted into the connector (1), it will press the slider (2) to move inward. At this time, the active end (31) of the control-rod (3) is moved alone the inner levels around the block (23), as the imaged line shown in FIG. 2, to a stable position at FIG. 3 for secure engagement, in which the memory-card is received in the connector (1). When to press the memory-card again, the slider (2) will be moved inward and the active end (31) of the control-rod (3) will be released from the block (23) and then moved alone the outer levels around the block (23) to the original position when the slider (2) is pushed outward by the spring (21), as imaged line shown in FIG. 4. The memory-card can be then taken out from the connector (1).

In above conventional movement, it contains the structure including the control-rod (3) moved around the block (23) for engaging and releasing the memory-card. It is found that a necessary means must be provided in such prior apparatus. That is an elastic slice (41) must be formed on a cap (4) of the connector (1) for pressing the control-rod (3) received in the groove (22) of the slider (2) all the time. As shown in FIGS. 5 and 6, the known elastic slice (41) has a long length that is not effective to elastically press the control rod (3). Moreover, in order to prevent from pushing the long elastic slice (41) overhead during movement of the control-rod (3), the thickness of the prior connector (1) cannot be reduced effectively.

### SUMMARY OF THE INVENTION

The present invention is to provide an improved positioning apparatus of a memory-card connector, which includes an arm-slice extended from the cap sideward and just contacted with the outer end of the control rod. It provides enough elastic force to press the control rod. Now, accompanying with the following drawings, the character of the present invention will be described here and after.

### BRIEF DESCRIPTION OF THE DRAWINGS

FIG. 1 is a schematic cross-sectional plan view showing a connector before receiving a memory-card.

FIG. 2 is a partly top plan view of FIG. 1.

FIG. 3 is a schematic cross-sectional plan view showing a connector after receiving a memory-card.

FIG. 4 is a partly top plan view of FIG. 3.

FIG. 5 is a schematic cross-sectional plan view showing a conventional connector.

FIG. 6 is a partly top plan view of FIG. 5.

FIG. 7 is a schematic cross-sectional plan view showing a connector according to the present invention.

FIG. 8 is a partly top plan view of FIG. 7.

FIG. 9 is an exploded perspective view showing the connector according to the present invention.

FIG. 10 is an assembled perspective view of FIG. 9.

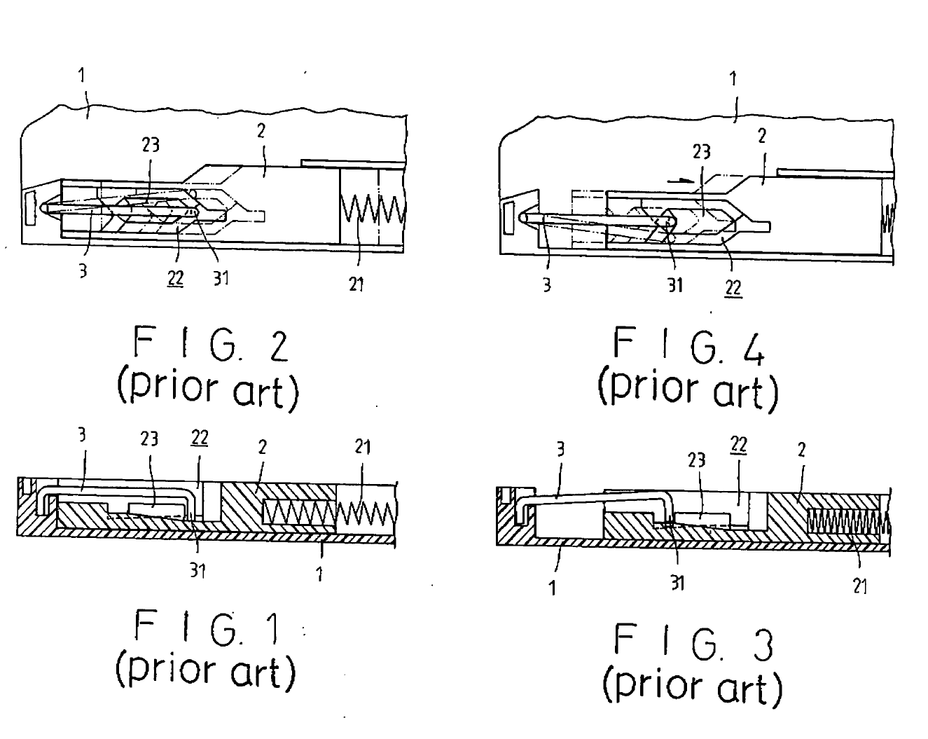

### DETAILED DESCRIPTION OF THE PREFERRED EMBODIMENT

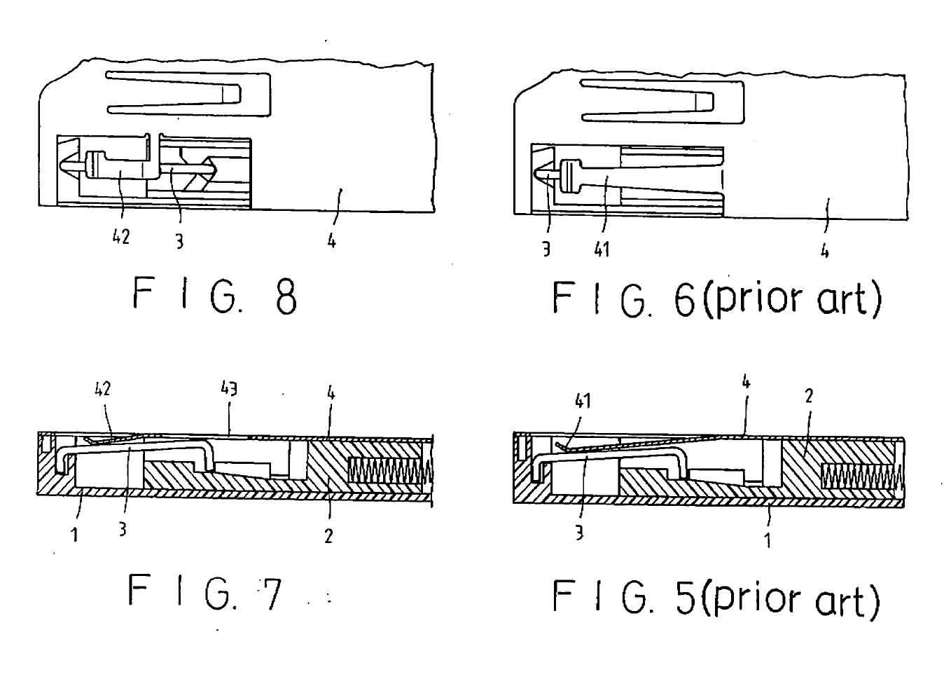

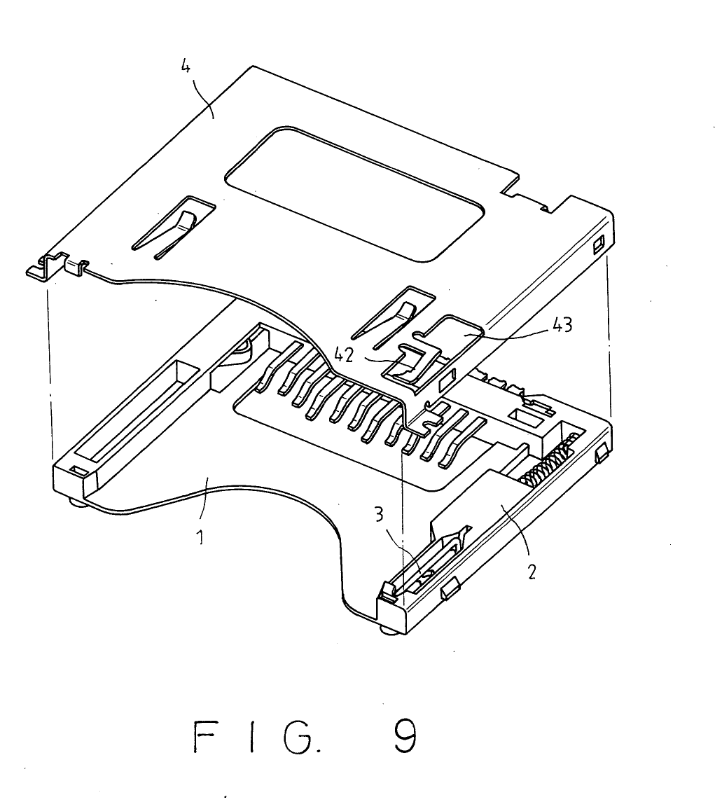

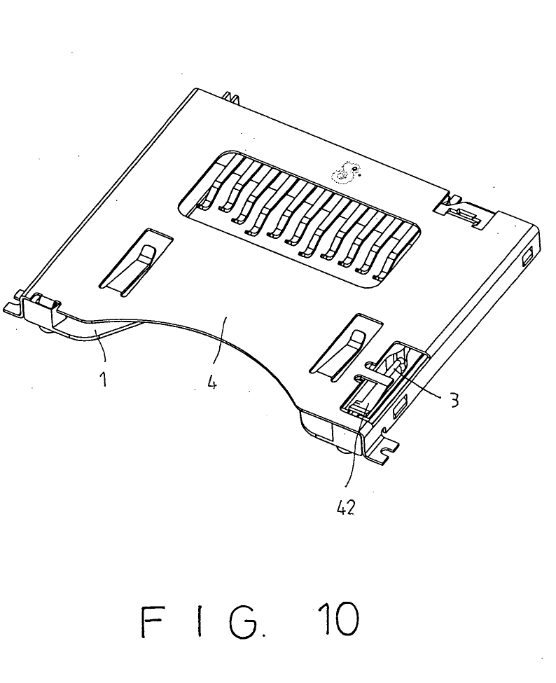

Please refer to FIGS. 7 and 8, the present invention relates to an improvement of a positioning apparatus of a memory-card connector, which includes a conventional slider (2) and a control rod (3). The character of the present invention is to provide an arm-slice (42) extended form the cap (4) sideward to press only the outer portion of the control rod (3). A space (43) is formed at the position relating to the active end (31) of the rod (3).

Please also refer to FIGS. 9 and 10, it can be found that the active end (31) of the control rod (3) will be prevented from limiting because of the space (43) while it is moved in the groove (22) of the slider (2). Hence, a thinner connector (1) can be manufactured by the present invention (Please compare with the FIGS. 5 and 7). Moreover, since the arm-slice (42) is extended sideward at middle position relating to the control rod (3), it can provide enough elastic strength for pressing the control rod (3) moved at corrective area. The application of the arm-slice is obviously better than any prior art and is utilized.

Accordingly, the present invention should be allowed for patent based on its improvement.

1. (canceled)

2. A positioning apparatus of a memory-card connector comprising:
a slider;
a control rod operably coupled to the slider, the control rod having outer and active end portions and an elongate intermediate portion extending longitudinally therebetween;
a cap disposed at least partially over the control rod and slider; and,
an arm-slice having a first portion projecting from the cap to be longitudinally spaced from the active end portion of the control rod and to extend transversely over the intermediate portion of the control rod, the arm-slice terminating at a second portion engaging the outer portion of the control rod.
